(19) United States
(12) Patent Application Publication
(10) Pub. No.: US 2010/0011759 A1
(43) Pub. Date: Jan. 21, 2010

(54) DEVICE AND METHOD FOR CONVERTING ENERGY

(75) Inventors: Ruud Rene Van der Woude, Alkmaar (NL); Jacobus Gerardus Maria Zutt, Sint Maartensvlotbrug (NL); Gerardus Jocobus Josephine Beckers, Sint Maarten (NL); Bouke Vriesema, Warmenhuizen (NL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ENATEC MICRO-COGEN B.V., Zevenaar (NL)

(21) Appl. No.: 11/913,667

(22) PCT Filed: Apr. 20, 2006
(86) PCT No.: PCT/NL06/50094

§ 371 Date: Sep. 11, 2009

(30) Foreign Application Priority Data
May 6, 2005 (NL) 1028982

(51) Int. Cl. F02G 1/043; F02B 71/00

(52) U.S. Cl. 60/520

(57) ABSTRACT

The present invention relates to a device for energy conversion, comprising: a housing provided with at least one chamber and a piston which is freely movable within said chamber, wherein said piston is capable of reciprocating movement from a central position or rest position, and wherein a gap between the piston and the wall of the chamber has a dimension that decreases as the piston moves further away from said central position or rest position.

In so-called free piston machines, which group of machines includes some Stirling engines and Stirling generators, a piston is connected to a non-moving or fixed environment by means of spring elements.

With such machines, the central position or rest position of the piston is the result of an equilibrium of forces between spring forces and pressure forces.

In a free piston Stirling machine, for example, the piston makes a periodic movement with amplitude A relative to an average central position which may differ from the static central position. The pressure values on both sides of the piston may exhibit periodic fluctuations with an amplitude ΔP relative to the average pressure Pₐᵥ.

When a difference between the average pressure in front of the piston and the average pressure behind the cylinder arises during operation of the machine, the average central position of the piston will be different from the static central position, which phenomenon is also referred to as axial drift. Said axial drift is undesirable.

In the past proposals have been made to overcome such axial drift, with one or more ports and/or channels being opened at a suitable moment so as to equalise pressure differences during a cycle of the machine.

The object of the present invention is to prevent drift as well as the use of trouble-prone and high-maintenance parts.

The present invention provides a device for energy conversion, comprising a housing provided with at least one chamber, a piston which is freely movable within said chamber, wherein said piston is capable of reciprocating movement from a central position or rest position, and wherein a gap between the piston and the wall of the chamber has a dimension that decreases as the piston moves further away from said central position or rest position.

Such a device is used advantageously in a system for combined generation of electricity and heat—see e.g. PCT/NL01/00399.

Further advantages, features and details of the present invention will be explained in the description below, in which reference is made to the appended drawings, in which:

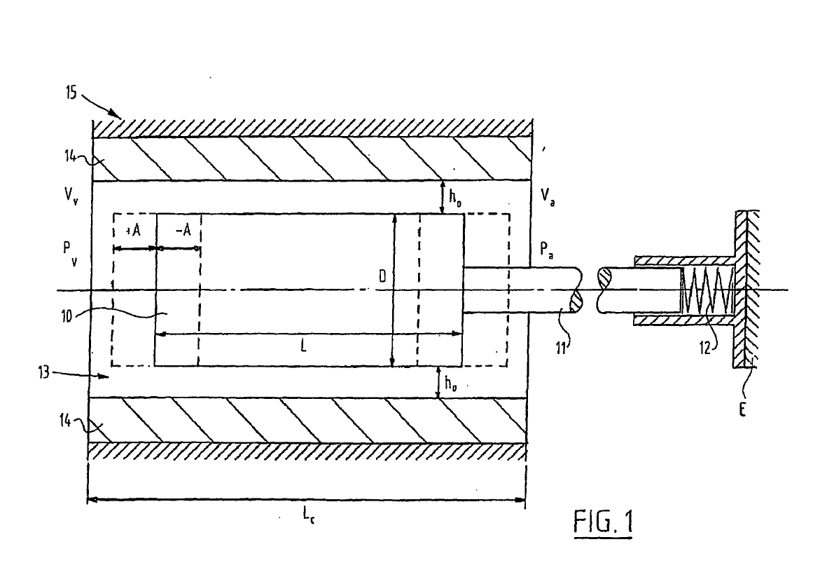

FIG. 1 is a schematic, sectional view of a Stirling machine in which the present invention can be implemented;

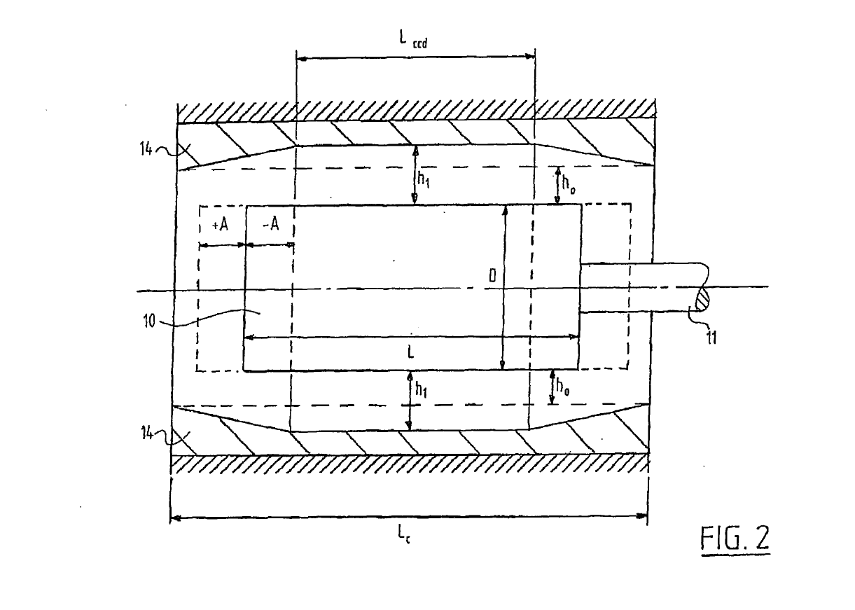

FIG. 2 is a sectional view of a first preferred embodiment of the present invention; and

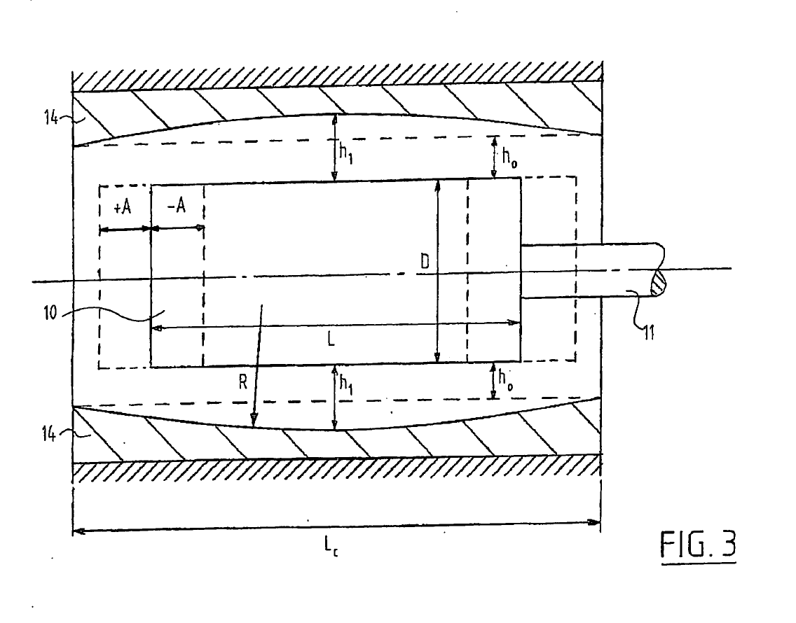

FIG. 3 is a sectional view of another preferred embodiment according to the present invention.

In a known Stirling machine, a free piston 10 (FIG. 1) is spring-mounted to a fixed environment E via a rod 11 and a spring 12. The free piston 10 is capable of reciprocating movement in a chamber 13 that is enclosed by substantially cylindrical walls 14 of a housing 15.

In the illustrated embodiment, the free piston 10 has a length L and a diameter D, whilst the piston travel with respect to the static central position is +A and −A, respectively. As regards the height hₒ of the annular space between the piston 10 and the cylindrical wall 14, the following applies: hₒ<<D. The pressure and the volume on the left-hand side of the free piston 10 are indicated Vᵥ and Pᵥ, respectively, whilst Vₐ and Pₐ, respectively, are used on the right-hand side. In the present invention, L_{c} is used to indicate the length of the chamber.

As regards L_{c}, the following applies:

L_{c}≧L+2A

The central position of the piston depends on the average pressures Pᵥ and Pₐ on the left-hand side and the right-hand side, respectively, of the free piston.

This axial drift may inadmissibly increase under certain circumstances, which leads to the free piston colliding with one of the cylinder ends, and thus to a general worsening of the performance of such a free piston machine.

In a first preferred embodiment of the present invention, the space between the inside wall of the chamber is wedge-shaped, seen in sectional view, i.e. the following applies as regards the height h:

1.0h₀≦h≦5.0h₀, preferably ≦2.0h₀.

For the value L_{ccd} the following formula applies:

0≦L_{ccd}≦L−2Aₘₐₓ−2x_{d,max}=L_{ccd,max}

wherein the following maximally allowable magnitude x_{d,max} of the axial drift applies with regard to x

x_{d,max}=½(L_{c}−L)−A.

With a chamber (or piston) configured in this manner, backflow past the piston is increased if different average pressure values prevail on the two sides of the piston, and thus the extent of axial drift remains limited.

In another preferred embodiment according to the present invention, an arcuate shape is used on one or both sides, in which case the following relation preferably applies with regard to the arc radius R:

$$R = \frac{1}{8} \frac{{L}_{c}^{2}}{{h}_{1} - {h}_{0}} if {h}_{0} , h 1 << {L}_{c} .$$

The present invention is not limited to the preferred embodiments as described above; the scope of the invention is defined in the appended claims.

1. A device for energy conversion, comprising:
a housing provided with at least one chamber;
a piston which is freely movable within said chamber, wherein said piston is capable of reciprocating movement from a central position or rest position, and wherein a gap between the piston and the wall of the chamber has a dimension that decreases as the piston moves further away from said central position or rest position.

2. A device according to claim 1, wherein the piston is mounted to a fixedly disposed mounting element via a piston rod.

3. A device according to claim 2, wherein the housing and the free piston form part of a Stirling machine.

4. A device according to claim 3, wherein the wall of the chamber is concave, seen from inside.

5. A device according to claim 4, wherein the wall of the chamber is wedge-shaped, seen from inside.

6. A device according to claim 1, wherein the housing and the free piston form part of a Stirling machine.

7. A device according to claim 6, wherein the wall of the chamber is concave, seen from inside.

8. A device according to claim 7, wherein the wall of the chamber is wedge-shaped, seen from inside.

9. A device according to claim 1, wherein the wall of the chamber is concave, seen from inside.

10. A device according to claim 9, wherein the wall of the chamber is wedge-shaped, seen from inside.

11. A device according to claim 1, wherein the wall of the chamber is wedge-shaped, seen from inside.

12. A method for converting energy, wherein a device according to any one of claims 1-11 is used.
